(19) United States
(12) Patent Application Publication
(10) Pub. No.: US 2018/0086137 A1
(43) Pub. Date: Mar. 29, 2018

(54) Rim Guard for an Automobile Rim

(71) Applicants: Elvin Smith, Charleston, WV (US); Mark Allen, Mount Nebo, WV (US)

(72) Inventors: Elvin Smith, Charleston, WV (US); Mark Allen, Mount Nebo, WV (US)

(21) Appl. No.: 15/280,830

(22) Filed: Sep. 29, 2016

(51) Int. Cl. B60B 7/04; B60S 3/04

(52) U.S. Cl. CPC B60B 7/04; B60B 2900/511; B60B 2900/211; B60S 3/042

(57) ABSTRACT

This invention is a rim shield for covering an automobile rim and providing a seal between a flange of the automobile rim and a sidewall of the tire around the rim. The rim shield has a circular shaped body with a handle positioned on the side of the body and a channel formed along a periphery of the body on its bottom side, or the side that faces the rim. The channel houses an O-ring that is shaped in a manner that allows the O-ring to seal the space between the sidewall and the flange. Once in this position, the rim shield can be rotated using the handle in a secure seal between the O-ring and space defined by the sidewall and flange.

### BACKGROUND OF THE INVENTION

In general, a wheel is a disk on an automobile that is mechanically coupled with the automobile's axle and fitted with an inflatable tire. In today's market, these wheels are no longer just about functionality but are about style and personality and almost all automobiles today come with wheels that have a unique style that can be unique to a particular automobile brand and product. Not to mention, there is a robust after-market that provides consumers with other options to fit their automobile with wheel of all kinds of different sizes, shapes, and designs. As such, a lot of people take a lot of pride and place a lot of value in the wheel on their automobiles. In addition, many people derive significant pleasure from thoroughly cleaning their tires and rims. One aspect of thoroughly cleaning their tires is to apply a polish or similar oily substance to the tires in order to make the tire appear shiny. However, many consumers find it difficult to apply a sufficient coat of a tire spray or polish to the tires without also inadvertently applying some of the tire spray or polish onto the wheel.

Traditionally, the tire gloss and the foaming tire cleaner should be kept off the rim as, at best, they will leave a residue, and in some cases can stain or even be corrosive to the rim.

There have been a number of solutions provided for protecting wheel rims and a few of them have been discussed below.

U.S. Pat. No. 6,464,303 B2 relates to a decorative safety attachment for tire rims including a circular plate dimensioned for positioning over the wheel rim. The circular plate has a diameter consistent with a diameter of the wheel rim. The circular plate has an inner surface, an outer surface, and a peripheral edge. The outer surface is coated with a reflective surface. The outer surface has a plurality of concentric annular grooves formed therein.

U.S. Pat. No. 6,412,878 B1 describes a simple, inexpensive, disposable wheel shield, i.e. suitable for protecting an automobile wheel during the application of a tire cleaner or dressing. The diameter of the shield may be adjusted by removing one or more of the five outer perforated concentric circles. A perforated circle in the center of the shield may be removed to accommodate a protruding four-wheel-drive front axle. The shield is held in place against the wheel by holding a push-out tab with one hand while applying cleaner to the tire with the other hand.

The aforesaid documents and other similar solutions may strive to provide an effective covering structure through the vehicle rim; however, they still have a number of limitations and shortcomings such as, but not limited to, difficult in securely applying a protective rim cover onto the wheel rim, complicated structures and further, the use of the material to produce the structure. The above mentioned prior art fails to understand wheel and tire structures and proper sealants that can take advantage of the wheel and tire structures that would more effectively protect the wheel rim from a tire spray or any type of polish.

Accordingly, a need exists for a structure that is able to optimize the structure of the tire and wheel rim in order to protect the rim from inadvertent application of various tire cleaning and polishing products so that the consumer is spared the extra and difficult step of removing such products from the tire rim or hubcap.

### SUMMARY OF THE INVENTION

In the view of the foregoing disadvantages inherent in the known types of the rim guard or rim cover now present in the prior art, the present invention provides an improved rim shield. As such, the general purpose of the present invention, which will be described subsequently in greater detail, is to provide a new and improved rim shield, which has all the advantages of the prior art and none of the disadvantages.

An object of the invention is to provide a rim shield having a shape structure and dimensions suitable for covering an automobile wheel rim of a specified size, shape, and configuration. In spirit of innovative aspects of the invention, the automobile rim includes a flange separating a base portion of the automobile rim and a groove around the outer edge of the flange and rim that seals with a tire bead and sidewall of an automobile tire. The rim shield includes a circular shaped body having having a top side, a bottom side and a periphery edge around the body and a handle positioned centrally on the top side. The rim shield further includes a channel formed alone the bottom side of the body near in proximity with the periphery. The rim shield further includes a flexible gasket disposed within the channel that is of a shape and structure that seals a space defined by the flange.

A further object of the invention is to provide the rim shield with a form that seals the base portion of the automobile rim. A further object is to provide the rim shield with a form that seals the groove around the outer edge of the flange and rim that seals with the tire bead and sidewall of the automobile tire.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is top view of a rim guard with an O-ring seal along the periphery according to an embodiment of the invention.

FIG. 2A is a side view of the rim guard with an O-ring seal along the periphery according to an embodiment of the invention.

FIG. 2B is an alternative side view of the rim guard with an O-ring seal along the periphery according to an embodiment of the invention.

FIG. 3 is a perspective and cut-away view of is a perspective view of an applicable use of a rim guard with a wheel rim and tire according to an embodiment of the invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

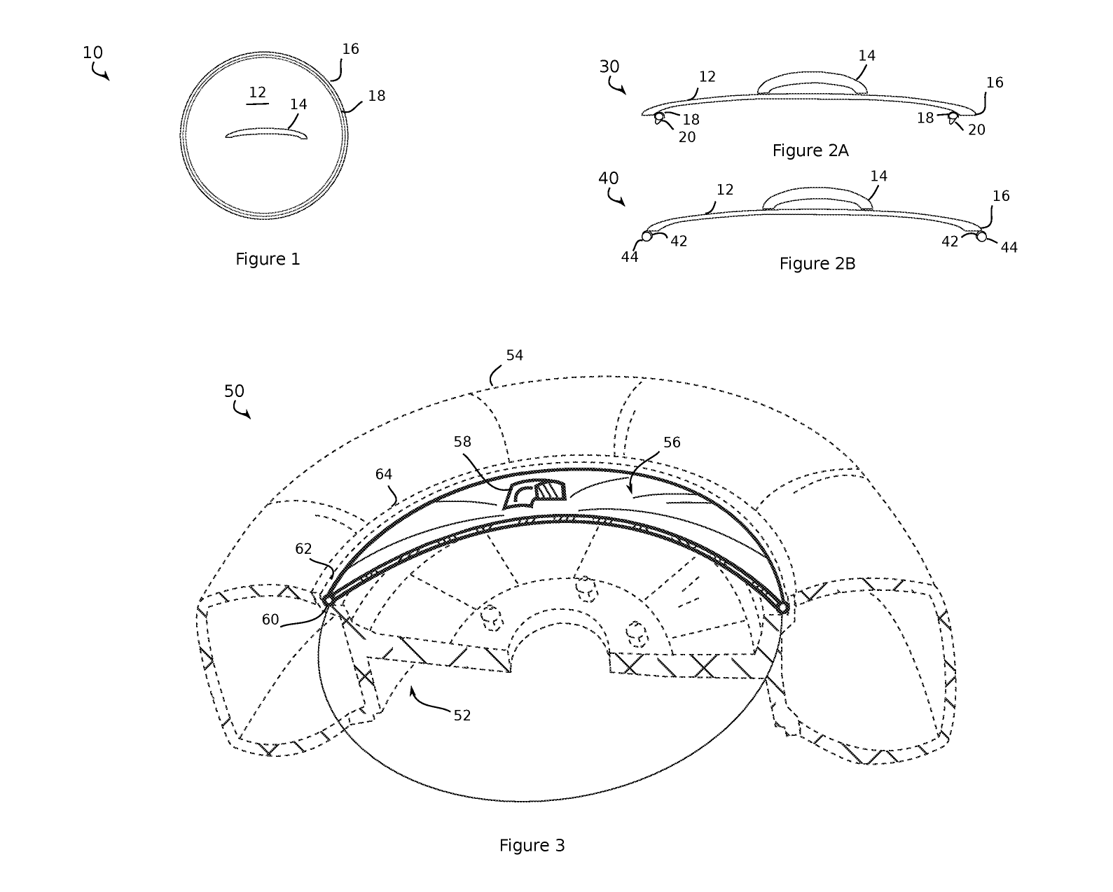

Referring to FIG. 1, illustrated is a top view of a rim guard with an O-ring seal along the periphery of the rim guard and is denoted generally as 10. The rim guard 10 includes a top body 12, a handle 14 on the top body 12 for maneuvering the rim guard, an outer periphery 16 of the body 12, and an inner channel 18 with an O-ring positioned within the inner channel 18. The inner channel 18 can also include a divider and the O-ring can be in separate pieces with each piece positioned within a divided section. The purpose of such is to prevent the O-ring from slipping or moving when pressure is applied. Although, it should be understood a purpose of the channel is to keep the O-ring in a stationary position and, as such, the channel can be designed in a manner to partially and securely enclose the O-ring so that movement is minimized. Furthermore, the channel provides a support structure that assists in sealing the O-ring with the rim. The rim guard 10 can be placed over a wheel rim of an automobile and depending on the shape and size of the wheel rim and tire around the wheel rim, the O-ring positioned within the channel 18 will have a size and shape that will accommodate the size and shape of the wheel rim necessary to seal the rim guard 10 with the wheel rim.

Referring now to FIG. 2A, illustrated is a side view of the rim guard 10 with an O-ring seal along the periphery and is denoted generally 30. The rim guard 30 includes the top body 12, the handle 14, the outer periphery 16, the inner channel 18, and an O-ring 20. In this embodiment, the inner channel 18 and the O-ring 20 are positioned in a manner along the periphery 16 of the rim guard 30 so that the O-ring 20 can best seat and possibly seal with a wheel rim and possibly tire of a certain style and shape. In other words, automobile wheel rims and tires are not of a standard form and are typically unique regardless of whether the wheel rim and tire is a product of before market or after-market sale. As such, the shape and position of the channel 18 and O-ring 20 will be unique pursuant to the requirements of the wheel rim and tire.

In this particular embodiment, the O-ring 20 includes a base body and a flange portion extending therefrom. The flange portion can be many different shapes but would include a shaped fit-able or conformable with a space between a flange of an automobile wheel rim and the space between the sidewall defined by the tire bead. It should also be understood that the location of the channel 18 could be positioned anyway along the periphery 16. Stated differently, the manner of the teaching herein is directed to an O-ring that can seal the gap between a flange of an automobile rim and the sidewall of the tire fitted therewith. The specific shape of the O-ring in this application is not universal but rather specific to the wheel rim and possibly tire design.

Referring now to FIG. 2B, illustrated is an alternative side view of the rim guard 10 with an O-ring seal along the periphery and is denoted generally 40. The rim guard 40 includes the top body 12, the handle 14, the outer periphery 16, an inner channel 42, and an O-ring 44. In this embodiment, the inner channel 18 and the O-ring 42 are positioned in a manner along the periphery 16 of the rim guard 30 so that the O-ring 20 can best seat and possibly seal with a wheel rim and possibly tire of a certain type and style. In other words, automobile wheel rims and tires are not of a standard form and are typically unique regardless of whether the wheel rim and tire is a product of before market or after-market sale. As such, the shape and position of the channel 18 and O-ring 44 will be unique pursuant to the requirements of the wheel rim and tire.

In this particular embodiment, the O-ring 44 includes a rounded base body and no flange portion extending therefrom. Although, a flange portion is possible depending on the wheel rim and tire. However, the rounded base body can be many different shapes and sizes but would include a shape fit-able or conformable with a space compatible with an internal side flange of an automobile wheel rim, i.e. not the space between the outer flange and space defined by the side wall bead of the automobile tire. It should also be understood that the location of the channel 18 could be positioned anywhere along the periphery 16 suitable to fit on the internal flange of the wheel rim.

Referring now to FIG. 3, illustrated is a perspective and cut-away view of an applicable use of a rim guard with a wheel rim and tire and is denoted generally as 50. The illustration 50 includes a wheel rim 52, a tire 54, and rim guard 56. The rim guard 56 includes a handle 58 and an inner channel and O-ring denoted generally as 60 around the periphery of the rim guard 56. However, the placement of the inner channel and O-ring 60 along the periphery of the rim guard 56 is dependent on specifics of the design and shape of the wheel rim and possible tire used with the rim. Preferably, the rim guard 60 and the inner channel may be made of plastic, e.g. using injection molding and the O-ring made of rubber.

In this example illustration, the wheel rim 52 is of a design and shape wherein the design and shape of the rim guard 56 necessitates the need that the rim guard 56 includes an inner channel and O-ring 60 is positioned on an inner flange 62 of the wheel rim 52. However, it should be understood that in other embodiments the inner channel and O-ring 60 could be placed between the outer flange and side wall of the tire, denoted generally at 64, of the wheel rim 52. As such, depending on the shape, style, and configuration of the wheel rim 52 and tire 54, the rim guard 56 may be configured in a way to necessitate the specific needs. In any configuration, the wheel rim 52 and inner channel and O-ring 60 can be seal-able with the fitted forms of the flanges, e.g. using force applied using the handle 58 and the shape and configuration of the O-ring. Alternatively, an adhesive could be applied to the O-ring that could apply the force necessary to create the seal.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A wheel rim shield comprising:
a body having a top side, a bottom side and a periphery edge around the body;
a handle centrally disposed on the top side of the body;
a channel formed along the bottom side of the body adjacent the periphery of the body; and
a flexible gasket disposed within the channel.

2. The apparatus of claim 1 wherein the body seals a wheel rim.

3. The apparatus of claim 1, wherein the gasket seals against the tire bead and sidewall of an automobile tire.

4. The apparatus of claim 1, wherein the gasket comprises an extending flange portion adapted to couple to a peripheral edge of a wheel rim.

5. The apparatus of claim 1, wherein the gasket comprises an O-ring.
